(19) United States
(12) Patent Application Publication
(10) Pub. No.: US 2015/0256788 A1
(43) Pub. Date: Sep. 10, 2015

(54) PROJECTOR AND CONTROL METHOD FOR PROJECTOR

(71) Applicant: SEIKO EPSON CORPORATION, Tokyo (JP)

(72) Inventors: Takeshi FURIHATA, Okaya-Shi (JP); Hirokazu KAMATORI, Azumino-Shi (JP)

(21) Appl. No.: 14/633,779

(22) Filed: Feb. 27, 2015

(30) Foreign Application Priority Data
Mar. 6, 2014 (JP) 2014-043611

(51) Int. Cl. H04N 5/74; H04N 9/31

(52) U.S. Cl. CPC H04N 5/7441; H04N 9/3179; H04N 9/3197; H04N 2005/745

(57) ABSTRACT

A projector includes a light source, a light modulation device that modulates light emitted from the light source according to a video signal, a projection optical system that projects image light which is modulated by the light modulation device, a display unit that is provided in a main body of the projector, an acquisition unit that acquires information indicating a state regarding the video signal, and a control unit that displays the information indicating a state regarding the video signal, acquired by the acquisition unit, on the display unit.

The entire disclosure of Japanese Patent Application No. 2014-043611, filed Mar. 6, 2014, is expressly incorporated by reference herein.

### BACKGROUND

1. Technical Field

The present invention relates to a projector, and a control method for the projector.

2. Related Art

In the related art, a technique is disclosed in which an auxiliary display device which displays an auxiliary image regarding a projection apparatus is provided in a projector body or an accessory device such as a remote controller of the projection apparatus which projects an image (JP-A-2003-280088). According to such a projector, abnormalities such as a light source lamp failure or cooling fan stoppage may be displayed on the auxiliary display device, or a state in which a video signal is abnormal or is not input may be displayed thereon.

In recent years, communication standards of various digital video signals have become widespread. In such digital communication standards, a hot plug detection technique or an encryption technique (a copy protection technique) may be used. However, as in the projector disclosed in JP-A-2003-280088, if a “state in which a video signal is abnormal or is not input” is only displayed, analysis is difficult in a case where a problem of a video signal not being accurately displayed occurs. For this reason, there is a problem in that a user does not know what is wrong and how the situation should be handled in order to display a video.

### SUMMARY

An advantage of some aspects of the invention is to solve at least a part of the problems described above, and the invention can be implemented as the following forms or application examples.

### Application Example 1

This application example is directed to a projector including a light source; a light modulation device that modulates light emitted from the light source according to a video signal; a projection optical system that projects image light which is modulated by the light modulation device; a display unit that is provided in the main body of the projector; an acquisition unit that acquires information indicating a state regarding the video signal; and a control unit that displays the information indicating a state regarding the video signal, acquired by the acquisition unit, on the display unit.

The projector includes the display unit in the main body of the projector in addition to the projection optical system which modulates and projects light emitted from the light source. The acquisition unit acquires information indicating a state regarding the video signal. The control unit displays the information indicating a state regarding the video signal on the display unit. Consequently, in a case where the video signal is not accurately projected or displayed, the information indicating a state regarding the video signal is displayed on the display unit, and thus a problem can be easily analyzed.

### Application Example 2

This application example is directed to the projector according to the application example described above, wherein the projector further includes a clocking unit that clocks time, and the control unit detects whether or not inputting of the video signal to the projector is stable, and, if it is detected that the inputting of the video signal to the projector is not stable, the control unit displays information indicating that the inputting of the video signal is not stable and information indicating the time at which it is detected that the inputting of the video signal is not stable on the display unit.

The projector includes the clocking unit. The control unit detects whether or not inputting of the video signal to the projector is stable. If it is detected that the inputting of the video signal to the projector is not stable, the control unit displays information indicating that the inputting of the video signal is not stable and information indicating the time at which it is detected that the inputting of the video signal is not stable on the display unit. Consequently, a user can confirm that inputting of the video signal is not stable and the time thereof from the display unit. In addition, it is possible to analyze the inputting of the video signal which is unstable.

### Application Example 3

This application example is directed to the projector according to the application example described above, wherein the control unit changes a state of the projector from a first state in which projection of an image is performed to a second state in which projection of an image is not performed, the acquisition unit acquires the information indicating a state regarding the video signal in a case where the projector is in the first state and in a case where the projector is in the second state, and the control unit displays the information indicating a state regarding the video signal on the display unit in both cases where the projector is in the first state and the second state.

According to the projector, the control unit can change a state of the projector from the first state in which projection of an image is performed to the second state in which projection of an image is not performed. The acquisition unit acquires the information indicating a state regarding the video signal in both cases where the projector is in the first state and the second state. The control unit displays the information indicating a state regarding the video signal on the display unit in both cases where the projector is in the first state and the second state, on the basis of the information acquired by the acquisition unit. Consequently, a user can recognize the information indicating a state regarding the video signal from the display unit even in the second case where projection of an image is not performed.

### Application Example 4

This application example is directed to the projector according to the application example described above, wherein the video signal is a digital video signal.

### Application Example 5

This application example is directed to the projector according to the application example described above, wherein the acquisition unit acquires information indicating states of procedures performed in order for a video supply apparatus supplying the digital video signal and the projector to display a video.

According to the projector, the acquisition unit acquires the information indicating states of procedures (steps) performed in order for the video supply apparatus supplying the digital video signal and the projector to display a video. Consequently, in a case where a situation in which a video signal is not accurately projected or displayed has occurred in the digital video signal, states of the procedures performed in order to display a video are displayed on the display unit, and thus it is possible to easily perform analysis of a problem.

### Application Example 6

This application example is directed to the projector according to the application example described above, wherein the procedures performed in order to display a video include at least one of a process of detecting a physical connection between the video supply apparatus and the projector, a display characteristic acquisition process of information regarding display characteristics of the projector, a copy protection authentication process of the video supply apparatus and the projector, an error rate acquisition process in communication, and a process of acquiring the number of lanes of main data channels.

According to the projector, the procedures performed in order to display a video include at least one of the connection detection process, the display characteristic acquisition process, the copy protection authentication process, the error rate acquisition process in communication, and the process of acquiring the number of lanes of main data channels. Consequently, in a case where a situation in which a video signal is not accurately projected or displayed has occurred in the digital video signal, states of the procedures performed in order to display a video are displayed on the display unit, and thus it is possible to easily perform analysis of a problem.

### Application Example 7

This application example is directed to the projector according to the application example described above, wherein in the procedures performed in order to display a video, the connection detection process is a hot plug detection process, the display characteristic acquisition process is an extended display identification data (EDID) acquisition process, and the copy protection authentication process is a high-bandwidth digital content projection system (HDCP) authentication process.

According to the projector, the connection detection process is the hot plug detection process, the display characteristic acquisition process is the EDID acquisition process, and the copy protection authentication process is the HDCP authentication process. Consequently, in a case where a situation in which a video signal is not accurately projected or displayed has occurred in the digital video signal, states of the procedures performed in order to display a video are displayed on the display unit, and thus it is possible to easily perform analysis of a problem.

### Application Example 8

This application example is directed to the projector according to the application example described above, wherein the projector further includes a storage unit that stores the information indicating a state of the video signal, acquired by the acquisition unit.

According to the projector, the storage unit stores the information indicating a state of the video signal, acquired by the acquisition unit. In addition, the information can be displayed on the display unit. Consequently, the stored state regarding a video signal is analyzed, and thus it is possible to easily analyze a problem in a case where the video signal is not accurately projected or displayed.

### Application Example 9

This application example is directed to the projector according to the application example described above, wherein the storage unit stores a plurality of pieces of the information indicating a state regarding the video signal.

According to the projector, the storage unit can store a plurality of pieces of the information indicating a state regarding the video signal. Consequently, a plurality of states can be stored, and thus it is possible to easily analyze a problem. In addition, a plurality of problems can be analyzed.

### Application Example 10

This application example is directed to the projector according to the application example described above, wherein the control unit causes the acquisition unit to acquire the information indicating a state regarding the video signal and stores the information in the storage unit in at least one of a case where the video signal is determined and a case where a power-off operation of the projector is performed.

According to the projector, the control unit causes the acquisition unit to acquire the information indicating a state regarding the video signal and stores the information in the storage unit in at least one of a case where the video signal is determined and a case where a power-off operation of the projector is performed. Consequently, the stored state regarding a video signal is analyzed, and thus it is possible to easily analyze a problem in a case where the video signal is not accurately projected or displayed.

### Application Example 11

This application example is directed to the projector according to the application example described above, wherein the control unit monitors a state regarding the video signal, and, in which, in a case where it is detected that the state regarding the video signal irregularly changes, the control units stores information indicating the state regarding the video signal in the storage unit.

According to the projector, in a case where it is detected that the state regarding the video signal irregularly changes, the control units stores the information in the storage unit. In addition, the information can be displayed. Consequently, it is possible to easily analyze a problem in a case where a video signal becomes unstable.

### Application Example 12

This application example is directed to the projector according to the application example described above, wherein the projector further includes a communication unit that performs communication with an external apparatus of the projector, and the control unit reads the information indicating a state regarding the video signal, stored in the storage unit, and causes the communication unit to transmit the information.

According to the projector, the control unit reads the information indicating a state regarding the video signal stored in the storage unit and causes the communication unit to transmit the information. Consequently, the external apparatus of the projector can read the information indicating a state regarding the video signal from the projector. Consequently, it is possible to easily analyze a problem in a case where the video signal is not accurately projected or displayed.

### Application Example 13

This application example is directed to the projector according to the application example described above, wherein the control unit causes the communication unit to transmit the information indicating a state regarding the video signal, acquired by the acquisition unit.

According to the projector, the control unit can cause the communication unit to transmit the information indicating a state regarding the video signal, acquired by the acquisition unit. In other words, the control unit can transmit the information from the communication unit without using the storage unit. Consequently, the external apparatus can read the information indicating a state regarding the video signal from the projector in real time.

### Application Example 14

This application example is directed to the projector according to the application example described above, wherein in a case where it is detected that a state regarding the video signal irregularly changes, the control unit issues a command for initializing the projector.

According to the projector, in a case where it is detected that a state regarding the video signal irregularly changes, the control unit issues a command for initializing the projector. Consequently, if the projector is initialized, a problem that a state regarding a video signal irregularly changes may be solved. In addition, a user is not required to perform troublesome work such as restarting the projector, and thus it is possible to provide an apparatus having good operability.

### Application Example 15

This application example is directed to the projector according to the application example described above, wherein the digital video signal is any one of a high-definition multimedia interface (HDMI (registered trademark)), HDBaseT (registered trademark), and DisplayPort.

### Application Example 16

This application example is directed to a control method for a projector including a light source, a light modulation device that modulates light emitted from the light source according to a video signal, a projection optical system that projects image light which is modulated by the light modulation device, and a display unit that is provided in the main body of the projector, the method including acquiring information indicating a state regarding the video signal; and displaying the acquired information indicating a state regarding the video signal on the display unit.

According to the control method for the projector, in a case where the video signal is not accurately projected or displayed, the information indicating a state regarding the video signal is displayed, and thus a problem can be easily analyzed.

In addition, in a case where the above-described projector and control method for the projector are configured by using a computer provided in the projector, the forms and the application examples can be configured in aspects such as a program for realizing functions thereof, or a recording medium recording the program which can be read by the computer. The recording medium may employ various types of media which can be read by the computer, such as a flexible disk, a hard disk drive (HDD), a compact disk read only memory (CD-ROM), a digital versatile disk (DVD), a Blu-ray (registered trademark) disc, a magneto-optical disc, a nonvolatile memory card, an internal storage device (a semiconductor memory such as a random access memory (RAM) or a read only memory (ROM)) of the projector, and an external storage device (universal serial bus (USB) or the like).

### BRIEF DESCRIPTION OF THE DRAWINGS

The invention will be described with reference to the accompanying drawings, wherein like numbers reference like elements.

FIGS. 1A and 1B are perspective views of a projector according to an embodiment, in which FIG. 1A is a perspective view which is viewed from a front side, and FIG. 1B is a perspective view which is viewed from a rear side.

FIG. 2 is a block diagram illustrating a schematic configuration of the projector according to the embodiment.

FIG. 3 is a diagram illustrating a part of a rear surface of a casing.

FIG. 4 is a sequence chart illustrating procedures for displaying videos of a video supply apparatus and the projector in HDMI.

FIG. 5 is a flowchart illustrating a signal monitoring process in the projector.

FIG. 6 is a flowchart illustrating a signal monitoring process in a case where the projector can store a plurality of pieces of signal information.

FIG. 7 is a diagram illustrating a part of a display screen of signal information displayed on a display unit.

### DESCRIPTION OF EXEMPLARY EMBODIMENTS

### Embodiments

Hereinafter, as an embodiment, a description will be made of a projector including a display unit which displays information indicating a state regarding a video signal.

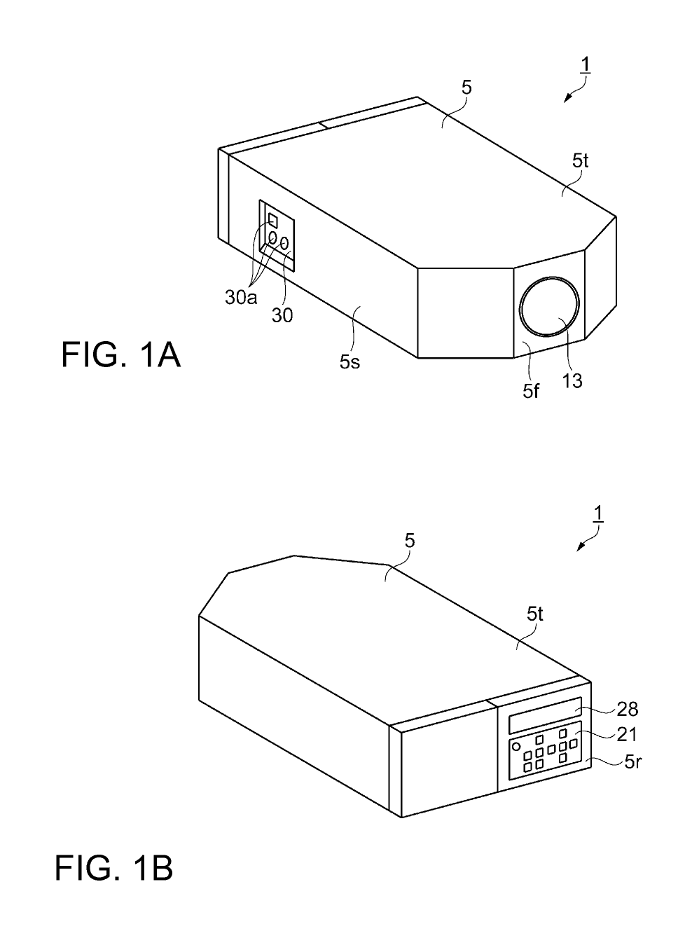

FIGS. 1A and 1B are perspective views of a projector according to the present embodiment, in which FIG. 1A is a perspective view which is viewed from a front side, and FIG. 1B is a perspective view which is viewed from a rear side.

As illustrated in FIG. 1A, a projector 1 includes a casing 5 which accommodates an apparatus body. A projection lens 13 is exposed on a front surface 5f of the casing 5. A video based on a video signal is projected from the projection lens 13 onto a projection surface (not illustrated in FIGS. 1A and 1B).

A video signal input unit 30 to which a video signal is input is provided on a side surface 5s of the casing 5. A plurality of input terminals 30a are provided in the video signal input unit 30.

A display unit 28 which displays information and an operation panel 21 which allows a user to perform an input operation are provided on a rear surface 5r of the casing 5.

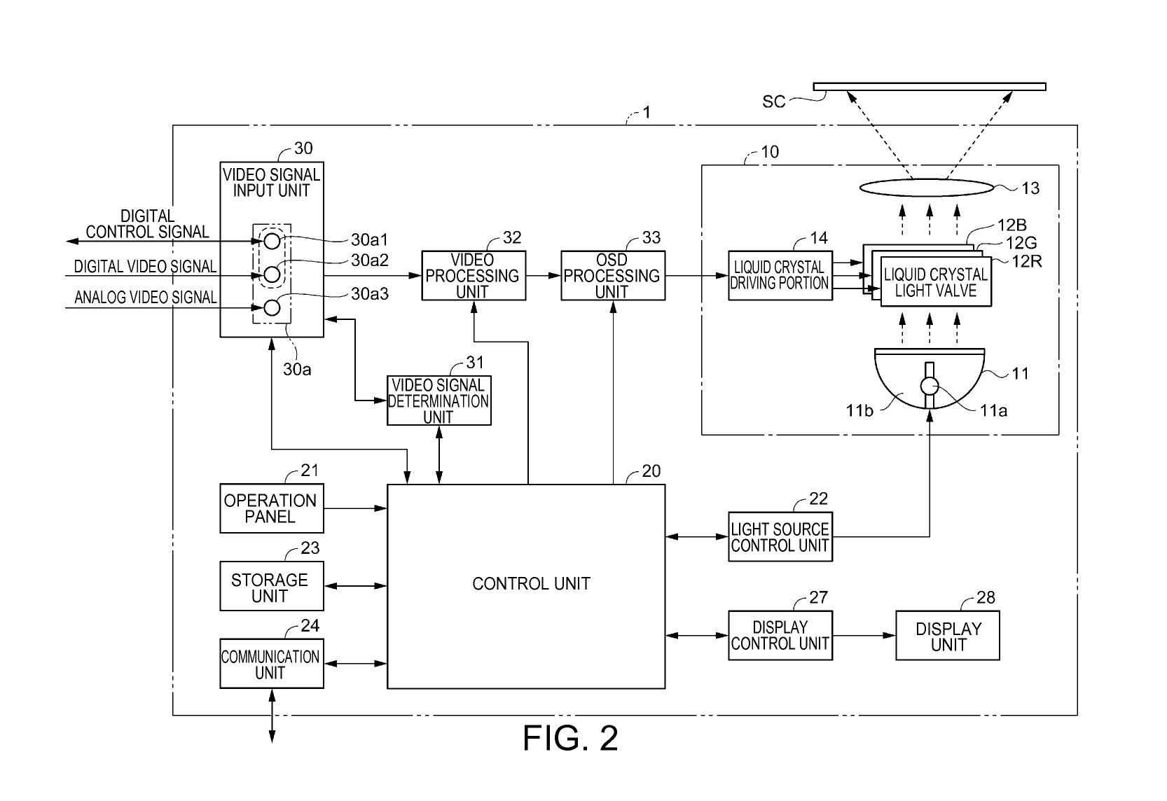

FIG. 2 is a block diagram illustrating a schematic configuration of the projector 1 according to the present embodiment. An internal configuration of the projector 1 will be described with reference to FIG. 2.

The projector 1 includes an image projection unit 10, a control unit 20, the operation panel 21 as an operation reception unit, a light source control unit 22, a storage unit 23, a communication unit 24, a display control unit 27, the display unit 28, the video signal input unit 30, a video signal determination unit 31, a video processing unit 32, an OSD processing unit 33, and the like. These configuration units are accommodated or disposed in the casing 5 (refer to FIGS. 1A and 1B).

The image projection unit 10 is constituted by a light source device 11 as a light source, three liquid crystal light valves 12R, 12G and 12B as a light modulation device, the projection lens 13 as a projection optical system, a liquid crystal driving portion 14, and the like.

The light source device 11 includes a discharge type light source lamp 11a constituted by an ultrahigh pressure mercury lamp, a metal halide lamp, or the like, and a reflector 11b which reflects light radiated from the light source lamp 11a toward the liquid crystal light valves 12R, 12G and 12B. Light emitted from the light source device 11 is converted into light of which luminance distribution is substantially uniform by an integrator optical system (not illustrated) and then is split into color light components including red (R), green (G), and blue (B) of three primary colors of light by a color splitting optical system (not illustrated), and the components are respectively incident to the liquid crystal light valves 12R, 12G and 12B.

Each of the liquid crystal light valves 12R, 12G and 12B is constituted by a liquid crystal panel in which liquid crystal is encapsulated between a pair of transparent substrates, and the like. Each of the liquid crystal light valves 12R, 12G and 12B includes a rectangular pixel region in which a plurality of pixels (not illustrated) are arranged in a matrix, and can apply a driving voltage to the liquid crystal for each pixel. When the liquid crystal driving portion 14 applies a driving voltage corresponding to input image information to each pixel, each pixel is set to light transmittance corresponding to the image information. For this reason, the light emitted from the light source device 11 is transmitted through the pixel regions of the liquid crystal light valves 12R, 12G and 12B so as to be modulated, and image light corresponding to the image information is formed for each color light. The formed light components of respective colors are combined with each other for each pixel by a color combining optical system (not illustrated) so as to be generated as color image light which is then enlargedly projected onto a projection surface such as a screen S by the projection lens 13.

The control unit 20 includes a central processing unit (CPU), a random access memory (RAM) which is used to temporarily store various items of data or the like, a read only memory (ROM) which is a nonvolatile memory, and the like. The CPU operates according to a control program stored in the ROM, and thus an operation of the projector 1 is comprehensively controlled. The control unit 20 has a clock function (not illustrated) and can detect the time. The clock function corresponds to a clocking unit. In addition, the control unit 20 has a timer (not illustrated) and can measure a predetermined period of time.

The operation panel 21 is provided on the rear surface 5r of the casing 5 of the projector 1 and includes a plurality of operation keys (object buttons) for giving various instructions to the projector 1.

Here, the operation panel 21 will be described.

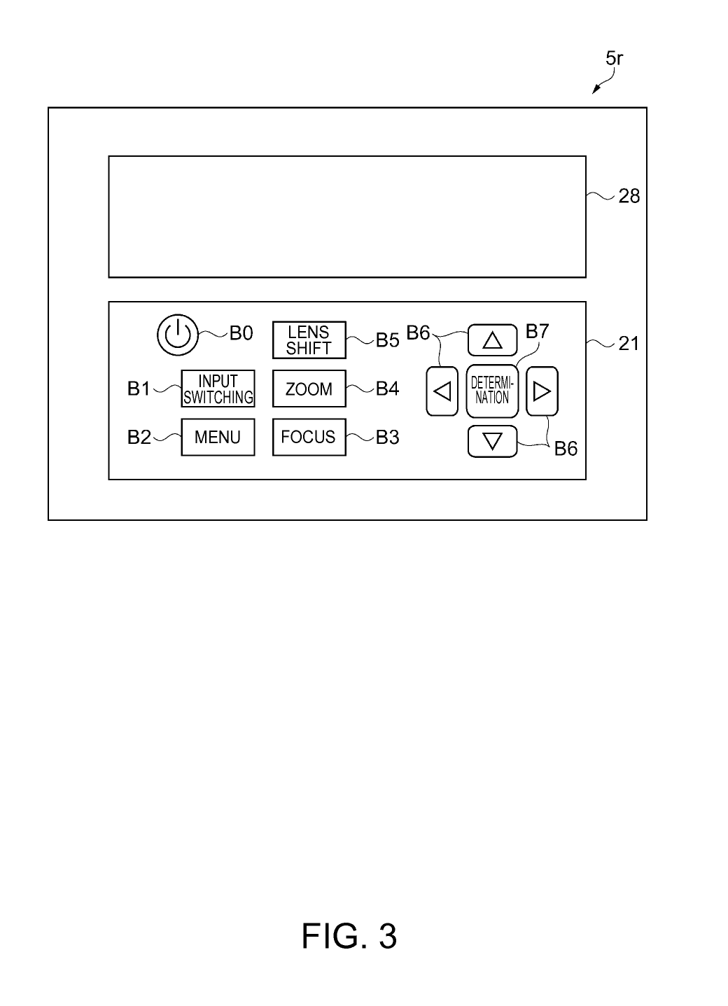

FIG. 3 is a diagram illustrating a part of the rear surface 5r of the casing 5.

As illustrated in FIG. 3, the display unit 28 and the operation panel 21 are provided on the rear surface 5r of the casing 5. The display unit 28 is constituted by a liquid crystal display or the like.

As the operation keys provided in the operation panel 21, there are a power key B0 for turning on and off power supply, an input switching key B1 for switching input image information, a menu key B2 for switching display and non-display of a menu screen for performing various settings, a focus adjustment start key B3 for starting a focus adjustment, a zoom adjustment start key B4 for starting a zoom adjustment, a lens shift adjustment start key B5 for starting a lens shift adjustment, cursor keys B6 used to move a cursor on a menu screen or to change a display screen of the display unit 28, a determination key B7 for determining various settings, and the like. When a user operates the operation panel 21, the operation panel 21 outputs control information corresponding to user's operation content to the control unit 20. In addition, the operation panel 21 may be provided with operation keys other than the above-described operation keys.

Instead of the operation panel 21 or along with the operation panel 21, a remote controller (not illustrated) which can perform a remote operation may be used as an input operation unit. In this case, the remote controller sends an operation signal corresponding to user's operation content such as infrared light, and a remote controller signal reception unit (not illustrated) receives and transmits the operation signal to the control unit 20.

Referring to FIG. 2 again, the light source control unit 22 controls supply and stoppage of power to the light source device 11 on the basis of an instruction from the control unit 20, and switches turning-on and turning-off of the light source device 11.

The storage unit 23 is constituted by a nonvolatile memory and stores information on a state regarding a video signal. The storage unit 23 can store a plurality of pieces of information on a state regarding a video signal. Writing and reading for the storage unit 23 are performed by the control unit 20. The control unit 20 writes the information on a state regarding a video signal to the storage unit 23 when a video signal input to the projector 1 is changed, a state of a video signal is changed, and power supply is stopped. During this time, the control unit 20 also writes time information to the storage unit 23. When a user performs a reading operation or the like, the control unit 20 reads the information on a state regarding a video signal and gives an instruction to the display control unit 27 so that the information is displayed on the display unit 28 or is transmitted from the communication unit 24.

The communication unit 24 performs communication with an external apparatus (not illustrated) such as a personal computer (PC) on the basis of an instruction from the control unit 20. Specifically, when a request is received from the external apparatus, the communication unit 24 notifies the control unit 20 of the request, and transmits the information on a state regarding a video signal to the external apparatus on the basis of an instruction from the control unit 20. The communication unit 24 may transmit the information on a state regarding a video signal stored in the storage unit 23 or may transmit a state regarding a video signal acquired by the video signal determination unit 31 and the control unit 20. Communication means used by the communication unit 24 may be communication means using Internet Protocol (IP) network communication, and may be communication means using communication based on RS-232C or a USB. Communication means is not limited thereto and may use other communication means.

The display control unit 27 controls image display for the display unit 28. The display control unit 27 includes a video RAM (VRAM) (not illustrated), generates image data of a state, information, or the like regarding a video signal in the screen unit on the VRAM on the basis of an instruction from the control unit 20, outputs the generated image data to the display unit 28, and displays an image based on the image data on the display unit 28.

The display unit 28 is constituted by, for example, a liquid crystal display, and displays an image corresponding to image data which is input from the display control unit 27. In the present embodiment, it is assumed that a display driving unit (not illustrated) driving the display unit 28 is built into the display unit 28. The display unit 28 is not limited to a liquid crystal display and may be constituted by other displays.

The display control unit 27 and the display unit 28 can display an image corresponding to image data in response to an instruction from the control unit 20 in a state in which the projector 1 is typically activated and performs projection and even in a state in which the projector 1 does not perform projection and can be operated via a network (also referred to as a “network standby state”). The state in which the projector 1 is typically activated and performs projection corresponds to a first state, and the network standby state corresponds to a second state.

The video signal input unit 30 includes the plurality of input terminals 30a, and receives video signals (image information) with various formats from an external video supply apparatus (not illustrated) such as a personal computer (PC), a video reproduction apparatus, a memory card, a USB storage, or a digital camera. The plurality of input terminals 30a include an HDMI terminal, an HDBaseT terminal, a DisplayPort terminal, an SDI terminal, a Thunderbolt (registered trademark) terminal, and the like as digital video signal terminals, and includes a VGA terminal, a CVBS terminal, an S-Video terminal, and the like as analog video signal terminals. The video signal input unit 30 may correspond to wireless transmission such as Wireless HD. In FIG. 2, for better understanding, the digital video signal terminals are illustrated to be divided into a digital control signal terminal 30a1 and a digital video signal terminal 30a2. The analog video signal terminals may be divided into a control signal terminal and a video signal terminal, but are illustrated to be put together into one analog video signal terminal 30a3, in FIG. 2, for simplification. The input terminals 30a are not limited to the above-described input terminals and may be other input terminals.

The video signal input unit 30 selects a video signal on the basis of an instruction from the control unit 20, and outputs the input video signal to the video signal determination unit 31 so that the type or a state of the video signal is determined. In addition, the video signal input unit 30 converts the video signal into video data with a format which can be processed by the video processing unit 32 on the basis of determination information from the video signal determination unit 31, and outputs the video data to the video processing unit 32.

The video signal determination unit 31 includes a receiver device of various digital video signals, an A/D converter, and the like (none illustrated), and determines the type or a state of a video signal which is input from the video signal input unit 30. The digital video signal receiver device of the video signal determination unit 31 performs procedures for displaying a video with the video supply apparatus by using a digital control signal or the like. Specifically, the digital video signal receiver device performs a detection process (for example, a hot plug detection process) of a physical connection between the video supply apparatus and the projector 1, a display characteristic acquisition process (for example, an EDID acquisition process) of the projector 1, a copy protection authentication process (for example, an HDCP authentication process) of the video supply apparatus and the projector 1, and the like. In addition, the digital video signal receiver device may perform an error rate acquisition process in communication, a lane number acquisition process of main data channels, and the like. These processes may be performed in cooperation of the control unit 20 and the receiver device. Further, processes performed in a procedure for displaying a video differ depending on the types of digital video signals.

The digital video signal receiver device includes a plurality of registers indicating information or a state regarding a video signal. The control unit 20 determines a state or information regarding a video signal by reading values of the registers so as to store the state or the information in the storage unit 23, or to display the state or the information on the display unit 28 by giving an instruction to the display control unit 27. Such a state or information regarding a video signal is referred to as “signal information”. The control unit 20 can check whether or not procedures for displaying a video are accurately performed on the basis of a state of a value of the register or a state of the control unit 20.

The control unit 20 may determine whether or not values of the registers are irregularly changed. For example, it is determined whether or not an irregular change occurs by determining a value of the register at a predetermined timing by using the timer or the like built into the control unit 20. As mentioned above, in a case where the control unit 20 determines that a value of the register irregularly changes, that is, a video signal is unstable, the control unit 20 stores a state or information regarding a video signal and time information in the storage unit 23.

In addition, in a case where the control unit 20 determines that a value of the register irregularly changes, that is, a video signal is unstable, the control unit 20 may issue an initialization command for initializing the projector 1. In a case where a video signal is unstable as mentioned above, whether or not the initialization command is issued may be set in a menu of the projector 1 in advance.

Here, a description will be made of procedures for displaying videos of the video supply apparatus and the projector 1.

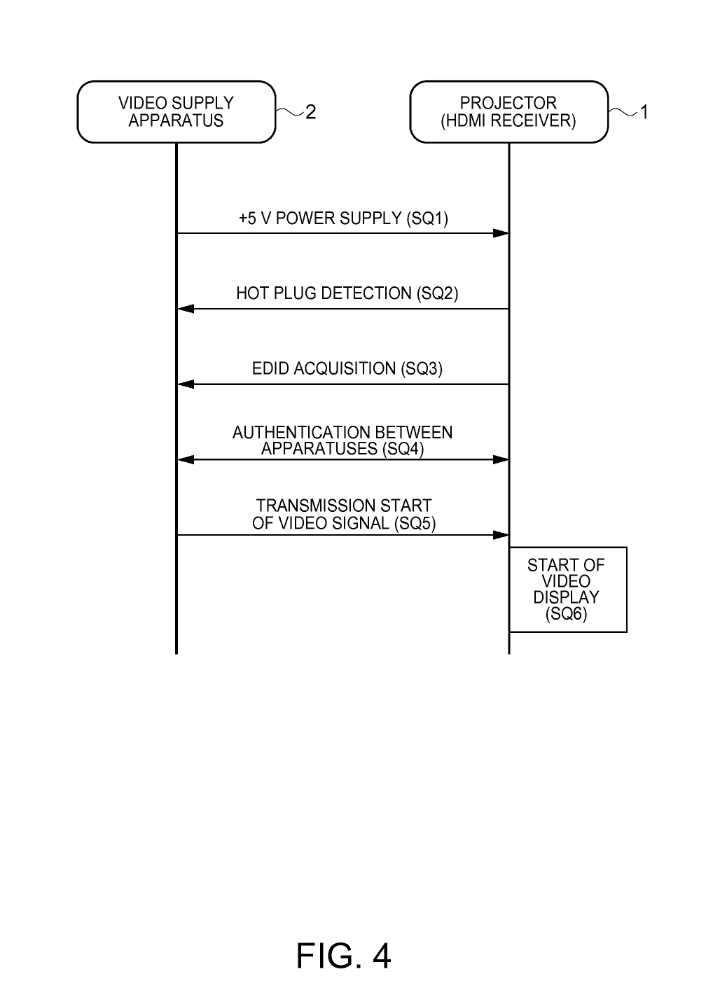

FIG. 4 is a sequence chart illustrating procedures for displaying videos of a video supply apparatus and the projector 1 in HDMI.

When the video supply apparatus 2 is connected to the projector 1 via an HDMI cable, the video supply apparatus 2 supplies power of +5 V to the projector 1 (sequence SQ1). When the power of +5 V is detected, the projector 1 notifies the video supply apparatus 2 of hot plug detection (sequence SQ2).

The video supply apparatus 2 acquires EDID from the projector 1 (sequence SQ3). The video supply apparatus 2 and the projector 1 perform authentication between the apparatuses (sequence SQ4). In addition, the video supply apparatus 2 starts transmission of a video signal to the projector 1 (sequence SQ5). The projector 1 starts the video display (projection) based on the video signal (sequence SQ6).

Referring to FIG. 2 again, the video processing unit 32 performs adjustments of brightness, contrast, sharpness, shade, and the like, or various image quality adjustments such as gamma correction, on video data which is input from the video signal input unit 30, on the basis of instructions from the control unit 20. The video processing unit 32 outputs the video data having undergone the adjustments and processes to the OSD processing unit 33.

The OSD processing unit 33 performs a process of superimposing an on-screen display (OSD) image such as a menu screen or a message screen on the video data which is input from the video processing unit 32, on the basis of an instruction from the control unit 20. The OSD processing unit 33 includes an OSD memory (not illustrated), and stores OSD image data indicating graphics, fonts, and the like for forming an OSD image. When the control unit 20 gives an instruction for superimposition of an OSD image, the OSD processing unit 33 reads the necessary OSD image data from the OSD memory, and combines the OSD image data with the video data which is input from the video processing unit 32 so that an OSD image is superimposed at a predetermined position of the input video. The video data which is combined with the OSD image data is output to the liquid crystal driving portion 14. In addition, in a case where there is no instruction for superimposition of an OSD image from the control unit 20, the OSD processing unit 33 outputs the video data which is output from the video processing unit 32, to the liquid crystal driving portion 14 without being combined.

When the liquid crystal driving portion 14 drives the liquid crystal light valves 12R, 12G and 12B on the basis of the video data which is input from the OSD processing unit 33, the liquid crystal light valves 12R, 12G and 12B modulates light which is incident from the light source device 11 into image light according to the video data, and the image light is projected from the projection lens 13.

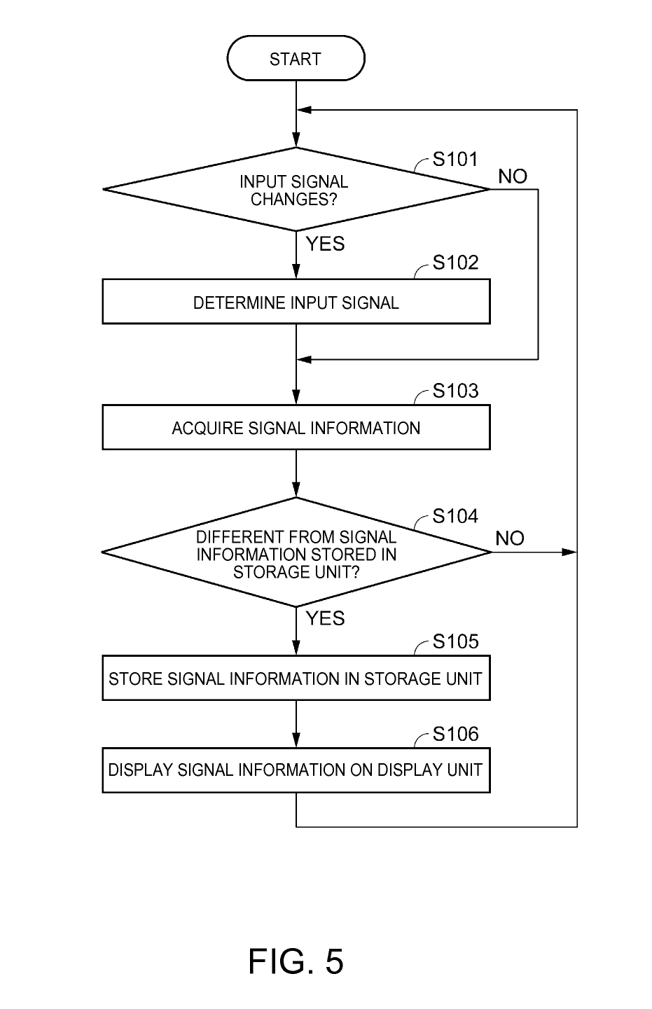

Next, with reference to a flowchart, a description will be made of a process in which signal information is stored and is displayed on the display unit 28 in a case where the signal information (state) of an input signal to the projector changes. FIG. 5 is a flowchart illustrating a signal monitoring process in the projector 1.

The control unit 20 detects whether or not an input signal changes on the basis of a notification from the video signal determination unit 31 (step S101). If the input signal does not change (step S101: NO), the flow proceeds to step S103.

If the input signal changes (step S101: YES), the control unit 20 and the video signal determination unit 31 determine the type of the input signal (step S102). The control unit 20 acquires signal information (state) from the video signal determination unit 31 and the control unit 20 (step S103). The video signal determination unit 31 and the control unit 20 correspond to an acquisition unit. The control unit 20 determines whether or not the acquired signal information is different from signal information stored in the storage unit 23 (step S104). If the acquired signal information is different from signal information stored in the storage unit 23 (step S104: NO), the flow returns to step S101, and a change in an input signal is monitored.

If the acquired signal information is different from signal information stored in the storage unit 23 (step S104: YES), the control unit 20 stores the signal information in the storage unit 23 (step S105). During this time, the control unit 20 also stores timing information in the storage unit 23. The control unit 20 gives an instruction to the display control unit 27 so that the signal information is displayed on the display unit 28 (step S106). Then, the flow returns to step S101, and a signal is continued to be monitored. Although not illustrated, the above-described signal monitoring process may be started or finished on the basis of a determination performed by the control unit 20.

Next, with reference to a flowchart, a description will be made of a process in which a plurality of pieces of signal information (state) can be stored in the storage unit 23 of the projector 1, and signal information of an input signal is stored and is displayed on the display unit 28.

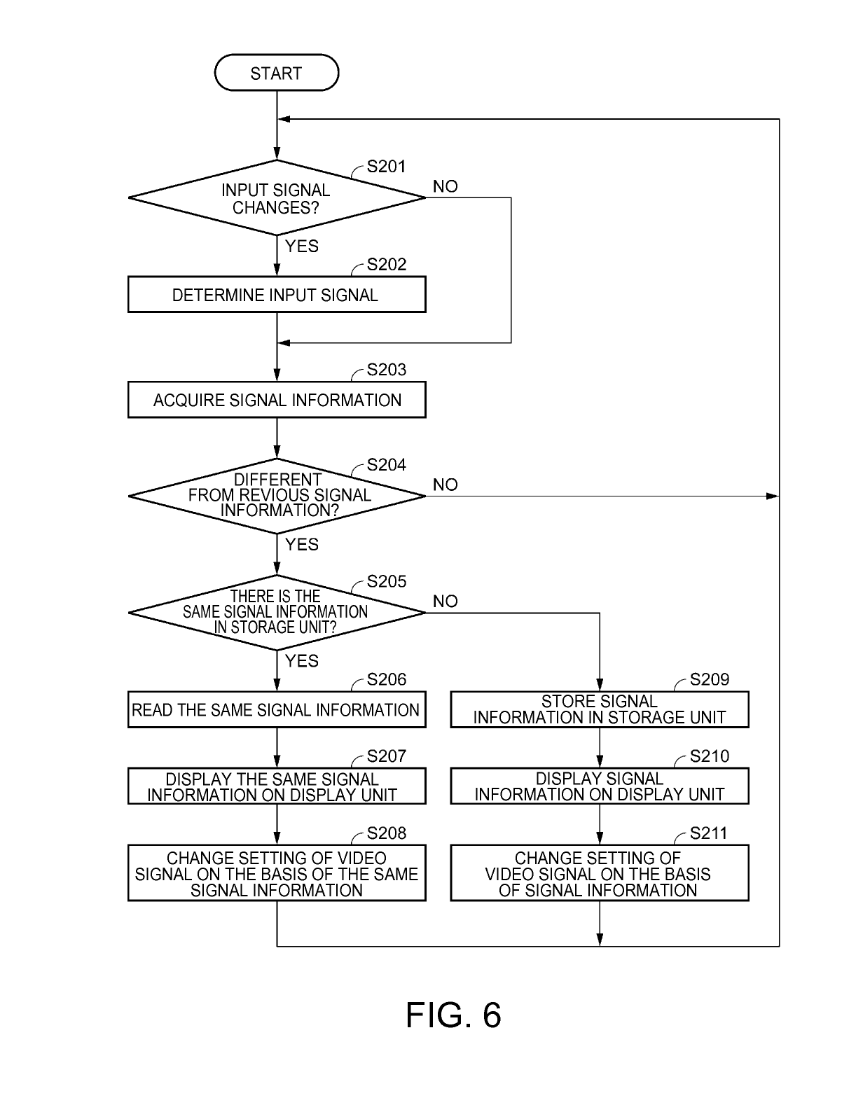

FIG. 6 is a flowchart illustrating a signal monitoring process in a case where the projector 1 can store a plurality of pieces of signal information.

The control unit 20 detects whether or not an input signal changes on the basis of a notification from the video signal determination unit 31 (step S201). If the input signal does not change (step S201: NO), the flow proceeds to step S203.

If the input signal changes (step S201: YES), the control unit 20 and the video signal determination unit 31 determine the type of input signal (step S202). The control unit 20 acquires signal information (state) from the video signal determination unit 31 and the control unit 20 (step S203).

The control unit 20 determines whether or not the signal information is different from the previous signal information (step S204). If the signal information is the same as the previous signal information (step S204: NO), the flow returns to step S201. If the signal information is different from the previous signal information (step S204: YES), the control unit 20 determines whether or not signal information which is the same as the signal information acquired during this time is stored in the storage unit 23 (step S205).

If signal information which is the same as the signal information acquired during this time is stored (step S205: YES), the control unit 20 reads the same signal information from the storage unit 23 (step S206). The control unit 20 gives an instruction to the display control unit 27 so that the read signal information is displayed on the display unit 28 (step S207). The control unit 20 changes a setting of the video signal on the basis of the same signal information (step S208). In addition, the flow returns to step S201, and an input signal is continued to be monitored.

If signal information which is the same as the signal information acquired during this time is not stored (step S205: NO), the control unit 20 stores (additionally writes) the acquired signal information in the storage unit 23 (step S209). During this time, the control unit 20 also stores time information in the storage unit 23. The control unit 20 gives an instruction to the display control unit 27 so that the acquired signal information is displayed on the display unit 28 (step S210). The control unit 20 changes a setting of the video signal on the basis of the acquired signal information (step S211). In addition, the flow returns to step S201, and an input signal is continued to be monitored. Although not illustrated, the above-described signal monitoring process may be started or finished on the basis of a determination performed by the control unit 20.

Here, a description will be made of signal information which is displayed on the display unit 28 or is stored in the storage unit 23 by the control unit 20.

In a case where a video signal is an HDMI signal, signal information (state) related to HDCP, EDID, Signal Information, a color space (the type or a standard of color information and/or signal), the number of bits (grayscale level (resolution)) of color information, and the like is displayed or stored.

In a case where a video signal is an HDBaseT signal, signal information related to an error rate, HDCP, EDID, Signal Information, a color space (the type or a standard of color information and/or signal), the number of bits (grayscale level (resolution)) of color information, and the like is displayed or stored.

In a case where a video signal is a DisplayPort signal, signal information related to the number of lanes, DPCP, EDID, Signal Information, a color space (the type or a standard of color information and/or signal), the number of bits (grayscale level (resolution)) of color information, and the like is displayed or stored.

In a case where a video signal is an SDI signal, signal information related to a resolution, a standard, a color space (the type or a standard of color information and/or signal), the number of bits (grayscale level (resolution)) of color information, and the like is displayed or stored.

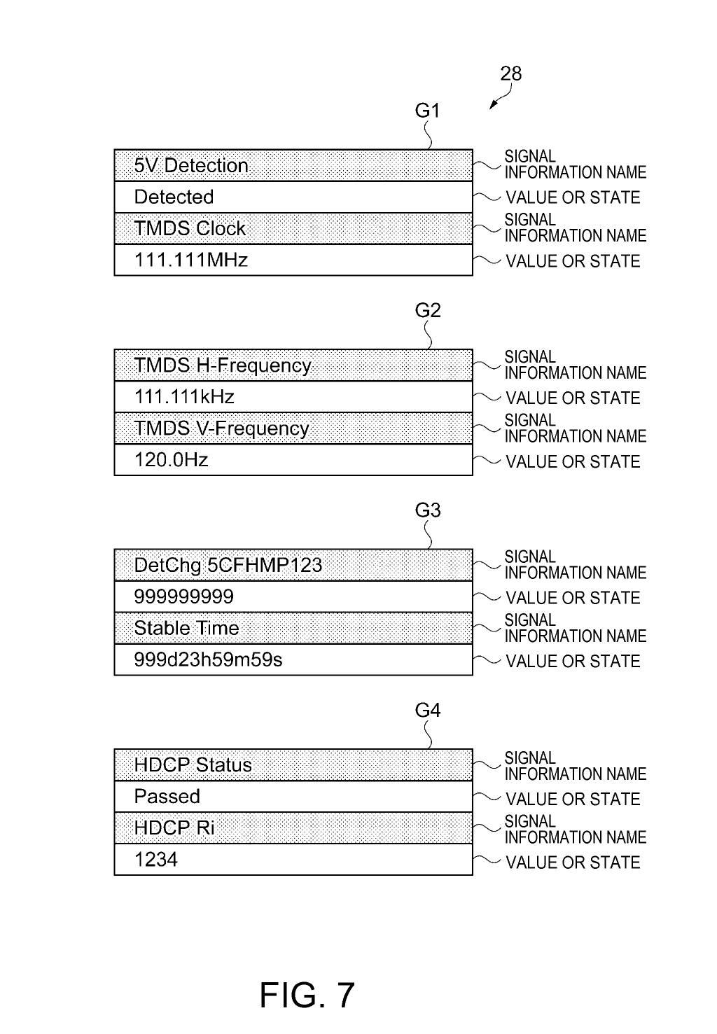

FIG. 7 is a diagram illustrating a part of a display screen of signal information displayed on the display unit 28. As illustrated in FIG. 7, the display unit 28 displays information indicating a state regarding a video signal. More specifically, the display unit 28 displays a screen indicating signal information (state) such as display screens G1, G2, G3 and G4. The display unit 28 displays not only the display screens but also various display screens. For example, in addition to the screen indicating a signal state, information indicating a system state (operation state) of the projector 1 may be displayed, or, when various abnormalities have occurred, information indicating that the abnormalities have occurred may be displayed. In addition, the change time of signal information (state) or the occurrence times of various abnormalities may be displayed.

Herein, a signal information name and a value or a state thereof are displayed on the display unit 28 in each of the display screens G1, G2, G3 and G4. In the present embodiment, in each of the display screens G1, G2, G3 and G4, display of four rows is performed, and two pieces of signal information (state) can be displayed on a single screen. A display aspect of the display unit 28 is not limited thereto. The display screen can be changed by using the cursor key B6 provided in the operation panel 21. Such signal information is also stored in the storage unit 23.

According to the above-described embodiment, the following effects can be achieved.

(1) The projector 1 includes the projection lens 13 which modulates and projects light which is emitted from the light source device 11, and the display unit 28 in the main body of the projector 1. The video signal determination unit 31 and the control unit 20 acquire a state regarding a video signal. The control unit 20 gives an instruction to the display control unit 27 so that a state or information (signal information) regarding a video signal is displayed on the display unit 28. Consequently, in a case where a video signal is not accurately projected or displayed, the display unit 28 is observed, and thus a problem can be easily analyzed. In addition, there is an advantage in that a problem which has occurred in the market can be easily analyzed, and thus a countermeasure to the problem can be taken fast. Further, a state regarding a video signal can be displayed even in the network standby state, and the convenience of problem analysis is improved.

(2) In the projector 1, the video signal determination unit 31 and the control unit 20 acquire states of procedures (steps) which are performed in order for the video supply apparatus 2 supplying a digital video signal and the projector 1 to display (project) a video. Consequently, in a case where a situation in which a video signal is not accurately projected or displayed has occurred in the digital video signal, states (signal information) of the procedures performed in order to display a video are displayed on the display unit 28, and thus it is possible to recognize which procedures have been performed and therefore to easily perform analysis of a problem and specifying of a problem location. In addition, it is possible to take countermeasures to solve the problem.

(3) According to the projector 1, procedures performed in order to display (project) a video include at least one of the hot plug detection process (connection detection process), the EDID acquisition process (display characteristic acquisition process), the HDCP authentication process (copy protection authentication process), the error rate acquisition process in communication, and the process of acquiring the number of lanes of main data channels. The kinds or names of the processes may differ depending on the type of digital video signal. Consequently, in a case where a situation in which a video signal is not accurately projected or displayed has occurred in the digital video signal, information indicating states of the procedures performed in order to display a video are displayed on the display unit 28, and thus it is possible to easily perform analysis of a problem and specifying of a problem location.

(4) The storage unit 23 of the projector 1 stores a state or information (signal information) regarding a video signal acquired by the video signal determination unit 31 and the control unit 20, and timing information. In addition, the information can be displayed on the display unit 28. Consequently, the stored state or information regarding a video signal is analyzed, and thus it is possible to easily analyze a problem in a case where the video signal was not accurately projected or displayed in the past. The storage unit 23 is configured to store a plurality of states or pieces of information regarding a video signal. Consequently, a plurality of states can be stored, and thus it is possible to easily perform analysis of a problem.

(5) The storage unit 23 of the projector 1 stores a plurality of pieces of signal information regarding a video signal. For this reason, in a signal setting process which is performed when an input signal changes (when a signal is determined) and which is performed for displaying (projecting) an input video signal, the signal information stored in the storage unit 23 can be used, and thus it is possible to simplify a setting change process during the signal setting process. In addition, in a case where there are a plurality of input signals, there is an advantage in that it is possible to rapidly and optimally perform a setting change process during a signal setting process when the signals are switched.

(6) The projector 1 acquires a state or information regarding a video signal and stores the state or the information in the storage unit 23 when a video signal is determined or signal information changes, and when a power-off operation of the projector 1 is performed. Consequently, the state or the information regarding a video signal stored when a video signal changes, and when a power-off operation is performed is analyzed, and thus it is possible to easily analyze a problem in a case where the video signal is not accurately projected or displayed. In addition, in a signal setting process which is performed when an input signal changes (when a signal is determined) and which is performed for displaying (projecting) an input video signal, the signal information stored in the storage unit 23 can be used, and thus it is possible to simplify a setting change process during the signal setting process.

(7) In a case where the control unit 20 of the projector 1 detects that a state regarding a video signal irregularly changes, signal information is stored in the storage unit 23. Consequently, it is possible to easily analyze a problem in a case where a video signal becomes unstable.

(8) The control unit 20 of the projector 1 reads a state or information regarding a video signal stored in the storage unit 23 so that the communication unit 24 transmits the state or the information. Consequently, an external apparatus of the projector 1 can read the state or the information regarding a video signal from the projector 1. The external apparatus of the projector 1 may use IP network communication or communication means based on RS-232C or a USB. As mentioned above, there is an advantage in that analysis of a problem in a case where a video signal is not accurately projected or displayed can be performed by the external apparatus without depending on only the display unit 28. If the IP network communication is used, analysis can be performed from a remote location.

(9) The control unit 20 of the projector 1 can cause the communication unit 24 to transmit a state regarding a video signal acquired by the video signal determination unit 31 and the control unit 20. In other words, the state regarding a video signal can be transmitted by the communication unit 24 without being stored in the storage unit 23. Consequently, the external apparatus can read the state regarding a video signal from the projector 1 in real time, and thus this is suitable for analysis at the site where a problem has occurred.

(10) In a case where the control unit 20 of the projector 1 detects that a state regarding a video signal irregularly changes, a command for initializing the projector 1 may be issued. Consequently, it is advantageous if the projector 1 is initialized, in that a problem that a state regarding a video signal irregularly changes may be solved.

(11) A digital video signal which can be projected by the projector 1 includes any one of HDMI, HDBaseT, and DisplayPort. In the projector 1, in a case where such a digital video signal is not accurately projected or displayed, it is possible to display states of procedures performed for displaying a video, or signal information (state) related to a resolution, a standard, Signal Information, a color space (the type or a standard of color information and/or signal), the number of bits (grayscale level (resolution)) of color information, and the like, on the display unit 28. In addition, the signal information (state) may be transmitted to an external apparatus by the communication unit 24. Therefore, analysis of a problem is easily performed. Further, an SDI signal may also be projected as a digital video signal. In a case of the SDI signal, signal information (state) related to a resolution, a standard, Signal Information, a color space (the type or a standard of color information and/or signal), the number of bits (grayscale level (resolution)) of color information, and the like may be displayed.

The invention is not limited to the above-described embodiment, and may be implemented through various modifications, improvements, and the like. Modification examples will be described below.

### Modification Example 1

In the above-described embodiment, various pieces of signal information (state) are displayed on the display unit 28, but may not only be displayed on the display unit 28 but may also be projected from the image projection unit 10.

### Modification Example 2

In the above-described embodiment, the storage unit 23 can store a plurality of pieces of information on a state regarding a video signal but may store only a single piece of information.

### Modification Example 3

In the above-described embodiment, a state or information regarding a video signal is acquired and stored in the storage unit 23 when a video signal is determined or signal information changes, and when a power-off operation of the projector 1 is performed, a state or information regarding a video signal may be periodically acquired and stored in the storage unit 23.

### Modification Example 4

In the above-described embodiment, the light source device 11 is constituted by the discharge type light source lamp 11a, but may use a light emitting diode (LED) light source, a solid-state diode such as a laser, or other light sources.

### Modification Example 5

In the above-described embodiment, the projector 1 uses the transmissive liquid crystal light valves 12R, 12G and 12B as a light modulation device, but may use a reflective light modulation device such as reflective liquid crystal light valves. In addition, a micromirror array device which controls an emission direction of incident light for each micromirror as a pixel and thus modulates light emitted from a light source may be used as a light modulation device.

What is claimed is:

1. A projector comprising:
a light source;
a light modulation device that modulates light emitted from the light source according to a video signal;
a projection optical system that projects image light which is modulated by the light modulation device;
a display unit that is provided in a main body of the projector;
an acquisition unit that acquires information indicating a state regarding the video signal; and
a control unit that displays the information indicating a state regarding the video signal, acquired by the acquisition unit, on the display unit.

2. The projector according to claim 1, further comprising:
a clocking unit that clocks time,
wherein the control unit detects whether or not inputting of the video signal to the projector is stable, and, if it is detected that the inputting of the video signal to the projector is not stable, the control unit displays information indicating that the inputting of the video signal is not stable and information indicating the time at which it is detected that the inputting of the video signal is not stable on the display unit.

3. The projector according to claim 1,
wherein the control unit changes a state of the projector from a first state in which projection of an image is performed to a second state in which projection of an image is not performed,
wherein the acquisition unit acquires the information indicating a state regarding the video signal in both cases where the projector is in the first state and the second state, and
wherein the control unit displays the information indicating a state regarding the video signal on the display unit in both cases where the projector is in the first state and the second state.

4. The projector according to claim 1,
wherein the video signal is a digital video signal.

5. The projector according to claim 4,
wherein the acquisition unit acquires information indicating states of procedures performed in order for a video supply apparatus supplying the digital video signal and the projector to display a video.

6. The projector according to claim 5,
wherein the procedures performed in order to display a video include at least one of a process of detecting a physical connection between the video supply apparatus and the projector, a display characteristic acquisition process of information regarding display characteristics of the projector, a copy protection authentication process of the video supply apparatus and the projector, an error rate acquisition process in communication, and a process of acquiring the number of lanes of main data channels.

7. The projector according to claim 6,
wherein, in the procedures performed in order to display a video, the connection detection process is a hot plug detection process, the display characteristic acquisition process is an EDID acquisition process, and the copy protection authentication process is an HDCP authentication process.

8. The projector according to claim 1, further comprising:
a storage unit that stores the information indicating a state of the video signal, acquired by the acquisition unit.

9. The projector according to claim 8,
wherein the storage unit stores a plurality of pieces of the information indicating a state regarding the video signal.

10. The projector according to claim 8,
wherein the control unit causes the acquisition unit to acquire the information indicating a state regarding the video signal and stores the information in the storage unit in at least one of a case where the video signal is determined and a case where a power-off operation of the projector is performed.

11. The projector according to claim 8,
wherein the control unit monitors a state regarding the video signal, and
wherein, in a case where it is detected that the state regarding the video signal irregularly changes, the control units stores information indicating the state regarding the video signal in the storage unit.

12. The projector according to claim 8, further comprising:
a communication unit that performs communication with an external apparatus of the projector,
wherein the control unit reads the information indicating a state regarding the video signal, stored in the storage unit, and causes the communication unit to transmit the information.

13. The projector according to claim 12,
wherein the control unit causes the communication unit to transmit the information indicating a state regarding the video signal, acquired by the acquisition unit.

14. The projector according to claim 1,
wherein, in a case where it is detected that a state regarding the video signal irregularly changes, the control unit issues a command for initializing the projector.

15. The projector according to claim 4,
wherein the digital video signal is any one of HDMI, HDBaseT, and DisplayPort.

16. A control method for a projector including a light source, a light modulation device that modulates light emitted from the light source according to a video signal, a projection optical system that projects image light which is modulated by the light modulation device, and a display unit that is provided in a main body of the projector, the method comprising:
acquiring information indicating a state regarding the video signal; and
displaying the acquired information indicating a state regarding the video signal on the display unit.
